(19) United States
(12) Patent Application Publication
(10) Pub. No.: US 2018/0113611 A1
(43) Pub. Date: Apr. 26, 2018

(54) Thunderbolt Flash Drive

(71) Applicant: Josef Rabinovitz, Chatsworth, CA (US)

(72) Inventor: Josef Rabinovitz, Chatsworth, CA (US)

(21) Appl. No.: 15/141,427

(22) Filed: Apr. 28, 2016

(51) Int. Cl. G06F 3/06; G06F 13/42

(52) U.S. Cl. CPC G06F 3/061; G06F 3/0655; G06F 2213/0026; G06F 13/4221; G06F 3/0679

(57) ABSTRACT

The present invention is a combination Thunderbolt cable assembly and Thunderbolt flash drive which includes a housing, a Thunderbolt cable assembly and a Thunderbolt flash drive. The Thunderbolt cable assembly includes a cable, a first cable connector and a second cable connector. The second cable connector is mechanically coupled to the housing. The Thunderbolt flash drive includes a PCI Express solid state device and a controller. The controller is electrically coupled to the PCI Express solid state device. The controller has a Thunderbolt mating connector and a PCI Express mating connector. The PCI Express solid state drive device is inserted into the PCI Express mating connector. The cable connector of the Thunderbolt cable assembly plugs into the Thunderbolt mating connector. The controller converts two lanes to Gen. 2 PCI-Express x4 and interfaces with the PCI Express solid state device via the PCI Express mating connector. The housing includes six rectangular plates, four rectangular thermal pads, four bushings and eight screws. Each rectangular plate has a hole in each of four corners each of which can receive one of four threaded bushings. One of the four bushings is inserted into the hole in each of the four corners of the first, second, third, fourth, fifth and sixth plates and one of each of eight screws is threadedly coupled to each end of the four bushings to form the housing.

### BACKGROUND OF THE INVENTION

### Field of the Invention

The field of the invention is solid state storage devices.

### Description of the Prior Art

In recent years, solid state drives (SSDs) have been used as a storage device for computing systems. SSDs may employ a nonvolatile memory (e.g., a flash memory) to store data. Compared with a typical hard disk drive, the SSD may be advantageous in terms of endurance, size, power, and so on. SSDs may be divided into a PCI (Peripheral Component Interconnect) SSD and a SATA (Serial Advanced Technology Attachment) SSD according to a communication method with a host.

Data storage devices are utilized in a wide variety of applications, referred to broadly herein as “user devices.” Data storage devices include solid state drives (SSD), hard disc drives (HDD) media memory cards, USB “thumb drives”, and so on. User devices include personal computers, digital cameras, camcorders, cellular phones, MP3 players, portable multimedia players (PMP), personal digital assistants (PDA), and so on. User systems typically include a host device (CPU, main memory, etc.) and a data storage device. The storage device may or may not be portable and detachable from the host device, and may include non-volatile memory and/or volatile memory. Volatile memory include DRAM and SRAM. Nonvolatile memory include EEPROM, FRAM, PRAM, MRAM and flash memory. Conventional memory systems such as hard disks and compact disk/digital video disk (CD DVD) drives are not as rugged or power efficient as flash memory because they have moving parts that can be easily damaged. As a result, some conventional computer systems are replacing hard disk drives and optical CD/DVD drives with solid state drives (SSD). Replacing a conventional disk drive with an SSD is not entirely straightforward. One reason is because data stored in a conventional disk drive can be overwritten in its current location, but data stored in a flash memory of the SSD cannot be overwritten without first erasing an entire block of data. In other words, conventional disk drives have “write in place” capability, whereas flash memory does not. As a result, when a flash memory is required to coordinate with a host system that uses the memory access conventions of a conventional disk drive, the flash memory typically uses a flash translation layer (FTL), which is a driver that reconciles a logical address space used by the operating system with a physical address space used by the flash memory. The flash translation layer generally performs at least three functions. First, it divides the flash memory into pages that can be accessed by the host system. Second, it manages data stored in the flash memory so that the flash memory appears to have write in place capability, when in reality, new data is written to erased locations of the flash memory. Finally, the flash translation layer manages the flash memory so that erased locations are available for storing new data.

Managing the flash memory involves various operations. Whenever a logical address is overwritten, a page of data stored at a corresponding physical address is invalidated and new page of data is stored at a new physical address of the flash memory. Whenever a sufficient number of pages in the flash memory are invalidated, the FTL performs a “merge” operation whereby “valid” pages are transferred from source blocks containing invalid pages to destination blocks with available space. The purpose of the merge operation is to free up memory space occupied by invalidated blocks by erasing the source blocks.

The flash memory includes a plurality memory cells arranged in a memory cell array. The memory cell array is divided into a plurality of blocks, and each of the blocks is divided into a plurality of pages. The flash memory can be erased a block at a time, and it can be programmed or read a page at a time. However, once programmed, a page must be erased before it can be programmed again. Within a flash memory, each block is designated by a physical block address, or “physical block number” (PBN) and each page is designated by a physical page address, or “physical page number” (PPN). However, the host system accesses each block by a logical block address, or “logical block number” (LBN) and each page by a logical page address, or “logical page number” (LPN). To coordinate the host system with the flash memory, the FTL maintains a mapping between the logical block and page addresses and corresponding physical block and page addresses. Then, when the host system sends a logical block and page address to the flash memory, the FTL translates the logical block and page address into a physical block and page address.

One problem with conventional merge operations is that the host system is cannot determine when a merge operation occurs, since merge operations are determined by operations of the FTL which are transparent to the host system. Since FTL does not store information about a file system, such as a file allocation table, the FTL cannot determine whether the host system considers a page invalid. In some instances, a file system for the host system may mark certain pages for deletion without the awareness of the FTL. As a result, a merge operation performed by the FTL may copy pages that are invalid from the host system's point of view. As a result, the merge operation takes more time than it should, thus degrading the performance of the memory system.

U.S. Patent Publication No. 2014/0149706 teaches a data transferring method of a storage device which may include transferring a first data to a first outbound area, transferring the first data sent to the first outbound area to a first area of a main memory corresponding to a first address programmed by an address translation unit, transferring a second data to a second outbound area in response to an indication that the address translation unit is to be reprogrammed, and transferring the second data sent to the second outbound area to the first outbound area.

U.S. Pat. No. 8,990,462 teaches a data transfer method of a storage device which includes a host bus adaptor to communicate with an external host via a first interface and to communicate internally via a second interface is provided. The data transfer method may include issuing a write command and a read command to the host bus adaptor; performing a read direct memory access operation using the first interface in response to the write command and simultaneously performing a write direct memory access operation using the second interface in response to the read command; and generating frame information structure (FIS) sequences according to the second interface in response to the issued write command and the issued read command. The first interface may perform a full duplex data transfer and the second interface may perform a half-duplex data transfer.

U.S. Pat. No. 8,533,391 teaches a storage device which includes a host interface, a buffer memory, a storage medium, and a controller. The host interface is configured to receive storage data and an invalidation command, where the invalidation command is indicative of invalid data among the storage data received by the host interface. The buffer memory is configured to temporarily store the storage data received by the host interface. The controller is configured to execute a transcribe operation in which the storage data temporarily stored in the buffer memory is selectively stored in the storage medium. The controller is responsive to is receipt of the invalidation command to execute a logging process when a memory capacity of the invalid data indicated by the invalidation command is equal to or greater than a reference capacity.

The applicant hereby incorporates the above referenced patents and patent publications into his specification.

### SUMMARY OF THE INVENTION

The invention is a combination Thunderbolt cable assembly and Thunderbolt flash drive which includes a housing, the aforementioned Thunderbolt cable assembly and a Thunderbolt flash drive. The Thunderbolt cable assembly includes a cable, a first cable connector and a second cable connector. The second cable connector is mechanically coupled to the housing. The Thunderbolt flash drive includes a PCI Express solid state memory device and a controller. The controller is electrically coupled to the PCI Express solid state memory device. The controller has a Thunderbolt mating connector and a PCI Express mating connector. The PCI Express solid state drive device is inserted into the PCI Express mating connector. The cable connector of the Thunderbolt cable assembly plugs into the Thunderbolt mating connector. The controller converts two lanes to Gen. 2 PCI-Express x4 and interfaces with is the PCI Express solid state device via the PCI Express mating connector.

In the first aspect of the invention the housing of the Thunderbolt flash drive includes six rectangular plates, four rectangular thermal pads which are thermoplastic or elastomeric material used for heat conduction and electrical insulation, four bushings and eight screws. Each rectangular plate has a hole in each of four corners each of which can receive one of four threaded bushings. One of the four bushings is inserted into the hole in each of the four corners of the first, second, third, fourth, fifth and sixth plates and one of each of eight screws is threadedly coupled to each end of the four bushings to form the housing.

In the second aspect of the invention the housing of the Thunderbolt flash drive is rugged and pocket-sized.

In the third aspect of the invention the housing of the Thunderbolt flash drive combines the advantages of Thunderbolt technology and PCI Express technology.

Other aspects and many of the attendant advantages will be more readily appreciated as the same becomes better understood by reference to the following detailed description and considered in connection with the accompanying drawing in which like reference symbols designate like parts throughout the figures.

From the foregoing it can be seen that a methods for assessing cognitive function in a subject have been described.

Accordingly it is intended that the foregoing disclosure and showing made in the drawing shall be considered only as an illustration of the principle of the present invention.

### DESCRIPTION OF THE DRAWINGS

FIG. 1 is a perspective view of a Thunderbolt flash drive in a housing and a Thunderbolt cable assembly according to the present invention.

FIG. 2 is an exploded perspective view of the Thunderbolt flash drive and the Thunderbolt cable assembly of FIG. 1 the housing of the Thunderbolt flash drive having a first plate, a first thermal pad, a second plate, a second thermal pad, a controller board with a connector coupling the controller board to the Thunderbolt cable assembly of FIG. 1, a third plate, a memory card, a fourth plate, a third thermal pad, a fifth plate, a fourth thermal pad and a sixth plate and a first threaded bushing, a second threaded bushing, a third threaded bushing, a fourth threaded bushing and eight screws.

FIG. 3 is an enlarged exploded perspective view of the Thunderbolt flash drive of FIG. 1 without the Thunderbolt cable assembly.

FIG. 4 is an enlarged exploded perspective view of the Thunderbolt flash drive of FIG. 2 without the Thunderbolt cable assembly rotated ninety degrees from the view in FIG. 3.

FIG. 5 is a perspective view of the first plate of the Thunderbolt flash drive of FIG. 2.

FIG. 6 is a perspective view of the second plate of the Thunderbolt flash drive of FIG. 2.

FIG. 7 is a perspective view of the third plate of the Thunderbolt flash drive of FIG. 2.

FIG. 8 is a perspective view of the fourth plate of the Thunderbolt flash drive of FIG. 2.

FIG. 9 is a perspective view of the fifth plate of the Thunderbolt flash drive of FIG. 2.

FIG. 10 is a perspective view of the sixth plate of the Thunderbolt flash drive of FIG. 2.

FIG. 11 is a front plan view of the first plate of FIG. 5.

FIG. 12 is a side elevation view of the first plate of FIG. 5.

FIG. 13 is a rear plan view of the first plate of FIG. 5.

FIG. 14 is a front plan view of the second plate of FIG. 6

FIG. 15 is a side elevation view of the second plate of FIG. 6

FIG. 16 is a rear plan view of the second plate of FIG. 6.

FIG. 17 is a front plan view of the third plate of FIG. 7.

FIG. 18 is a side elevation view of the third plate of FIG. 7.

FIG. 19 is a rear plan view of the third plate of FIG. 7.

FIG. 20 is a front plan view of the fourth plate of FIG. 8.

FIG. 21 is a side elevation view of the fourth plate of FIG. 8.

FIG. 22 is a rear plan view of the fourth plate of FIG. 8

FIG. 23 is a front plan view of the fifth plate of FIG. 9.

FIG. 24 is a side elevation view of the fifth plate of FIG. 9.

FIG. 25 is a rear plan view of the fifth plate of FIG. 9.

FIG. 26 is a front plan view of the sixth plate of FIG. 10.

FIG. 27 is a side elevation view of the sixth plate of FIG. 10.

FIG. 28 is a rear plan view of the sixth plate of FIG. 10.

FIG. 29 is a perspective view of the first thermal pad of the Thunderbolt flash drive of FIG. 2.

FIG. 30 is a perspective view of the second thermal pad of the Thunderbolt flash drive of FIG. 2.

FIG. 31 is a perspective view of the third thermal pad of the Thunderbolt flash drive of FIG. 2.

FIG. 32 is a perspective view of the fourth thermal pad of the Thunderbolt flash drive of FIG. 2.

FIG. 33 is a perspective view of the memory card of the Thunderbolt flash drive of FIG. 2.

FIG. 34 is a photograph of the memory card of FIG. 33.

FIG. 35 is a photograph of the memory card of FIG. 34 disposed in the PCIe connector of FIG. 2.

FIG. 36 is a photograph of the controller board of the Thunderbolt flash drive of FIG. 2

FIG. 37 is a photograph of the connector of the Thunderbolt flash drive of FIG. 2.

FIG. 38 is a top plan view of the controller board of the Thunderbolt flash drive of FIG. 2

FIG. 39 is a perspective view of the controller board of the Thunderbolt flash drive of FIG. 2 with the connector coupling the controller board to the Thunderbolt cable assembly of FIG. 1.

FIG. 40 is a block diagram schematically illustrating a first computing system which U.S. Patent Publication No. 2014/0149705 teaches and which has a first data storage device.

FIG. 41 is a block diagram schematically illustrating a second computing system which U.S. Pat. No. 8,990,462 teaches and which has a second data storage device.

FIG. 42 is a block diagram schematically illustrating a third computing system which is similar to the second computing system of FIG. 41 and which has a third data storage device.

FIG. 43 is a block diagram schematically illustrating a fourth computing system which U.S. Pat. No. 8,990,462 teaches and which has a fourth data storage device.

### DESCRIPTION OF THE PREFERRED EMBODIMENT

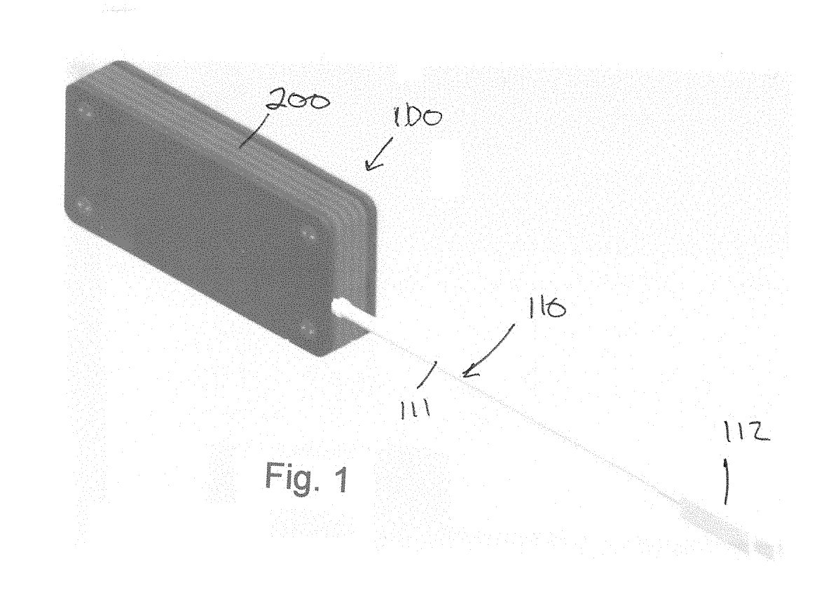

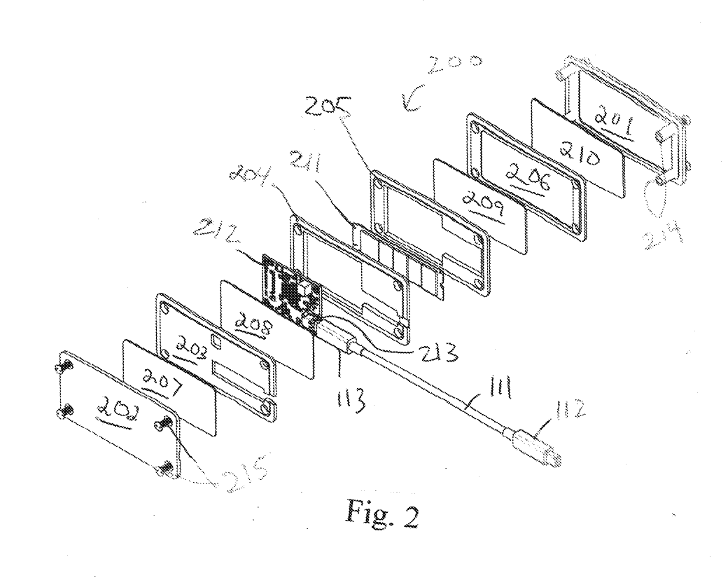

Referring to FIG. 1 in conjunction with FIG. 2 a combination Thunderbolt cable assembly and Thunderbolt flash drive includes a Thunderbolt cable assembly 110 and a Thunderbolt flash drive 200. The Thunderbolt cable assembly 110 has a cable 111 and one of two male Thunderbolt connectors 112 and 113 at each end. The second cable connector is mechanically coupled to the housing of a Thunderbolt flash drive 200. The housing of the Thunderbolt flash drive includes six rectangular plates 201, 202, 203, 204, 205 and 206, four rectangular thermal pads 207, 208, 209 and 210, a memory board 211 with a PCI Express mating connector 216, a controller board 212 with a Thunderbolt female mating connector 213, four bushings 214 and eight screws 215. Each rectangular plate has a hole in each of four corners each of which can receive one of four threaded bushings. One of the four bushings is inserted into the hole in each of the four corners of the first, second, third, fourth, fifth and sixth plates and one of each of eight screws is threadedly coupled to each end of the four bushings to form the housing. The Thunderbolt flash drive 200 is rugged and pocket-size. The Thunderbolt flash drive 200 combines the advantages of Thunderbolt technology and PCI Express technology.

The Thunderbolt flash drive 200 includes a PCI Express solid state memory device 211 and a controller 212. The controller 212 is on an interface board and is electrically coupled to the PCI Express solid state device 211. The controller has a Thunderbolt mating connector and the PCI Express mating connector. The PCI Express solid state drive device 211 is inserted into the PCI Express mating connector 216. The cable connector 113 of the Thunderbolt cable assembly 110 plugs into the Thunderbolt mating connector 213. The controller 212 converts two lanes to Gen. 2 PCI-Express x4 and interfaces with the PCI Express solid state device via the PCI Express mating connector.

The solid state drive design captivates the pre-attached Thunderbolt cable during assembly so the Thunderbolt cable assembly 110 cannot be stressed nor accidentally become disconnected. This is achieved by mechanical design of the “sandwich” assembly. The drawings which follow include exploded assembly diagrams indicating the aluminum fabrications, the elastomeric thermal transfer pads, the interface board, the M.2 PCI Express solid state device (SSD) board, bushings and machine screws used; also included are assembled views of the finished product. The application for the product is to provide extremely fast data transfers from a computing system using the Thunderbolt I-O interface to a small, portable storage device which may then be easily moved from place to place to load stored data (files) to a different computer which may read or modify those files, or add to or replace them, for ongoing use. The application is very similar to the ubiquitous “USB (universal serial bus) thumb drives” (flash memory devices with a pluggable USB interface) in common use for several years; the primary difference is the Thunderbolt interface, which operates at 20 Gb/s as opposed to USB 3.0 which operates at only 5 Gb/s data transfer rates. Thus, data transfers can occur at four times (or more) the speed, greatly accelerating workflow. When dealing with large files such as video formats, this can save users hours of time while still allowing use of a small, portable “bus-powered” (no external power supply required) device. The controller board 212 is an interface printed circuit board and is based on the Intel Reference Design. The M.2 interface connector 216 is on the back side of that circuit board, essentially folded beneath the controller board 212. The packaging method used to maintain a very small outline while enhancing the power dissipation ability by use of a “sandwich” consisting of six layers of custom aluminum fabrications along with thermally conducting adhesive insulating pads which are referred to as Silpads.

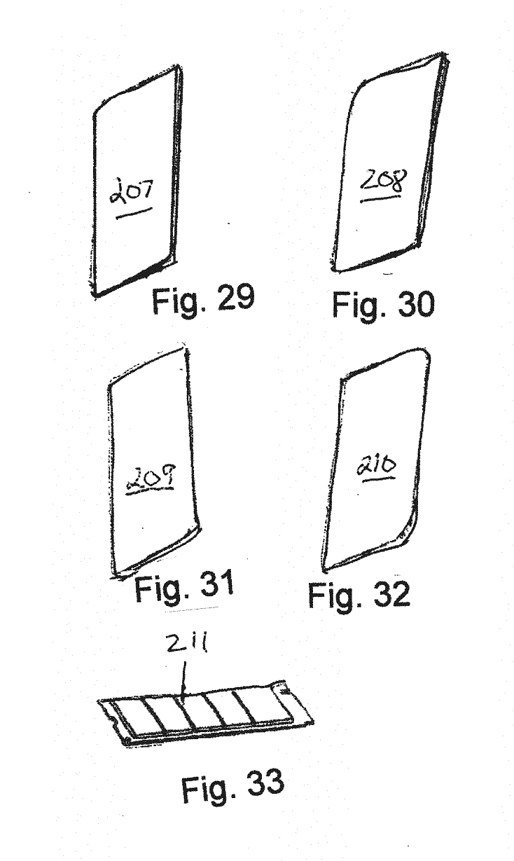

Referring to FIG. 29 in conjunction with FIG. 2, FIG. 3, FIG. 41, FIG. 30, FIG. 31 and FIG. 32 the first Silpad 207, the second Silpad 208, the third Silpad 209 and the fourth Silpad 210 are insulating and resilient pads which U.S. Pat. No. 3,964, 666 teaches and which are of a silicone rubber, such as the type sold by the Bergquist Company under the tradename “Silpad.” This type of silicone rubber is commercially available as a material to mount power transistors to heat sink bases. The particular silicone rubber is electrically insulating but has good thermal transmission characteristics. Particularly significant are the resiliency of the pad and its capacity to transfer heat. When located between exposure surfaces the Silpad is a conductive material which allows for extremely close and uniform contact between the exposure surfaces and a heat exchanger. The material chosen as the Silpad may be a silicone-based pad, Chomerics T500.RTM., supplied by Chomerics, located in Woburn, Mass. The Silpad allows for better heat transfer from the exposure surfaces to the heat exchanger than an interface of air would allow. The insulating pads are elastomeric thermal interfaces having excellent thermal conductivity to provide transfer from heat-generating components to the aluminum structure that creates the “sandwich” enclosure, which in turn dissipates the heat generated internally in a highly efficient manner.

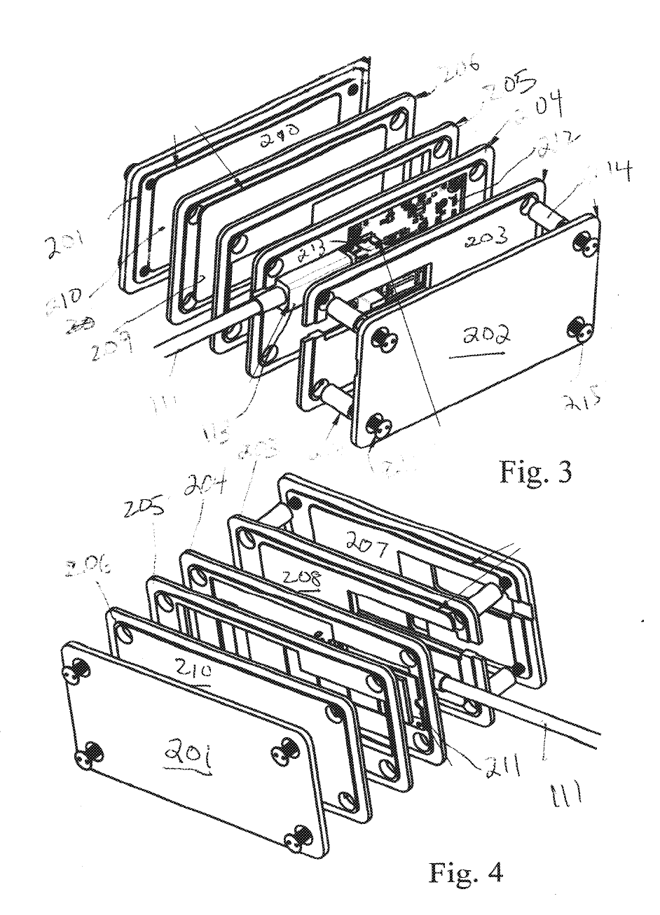

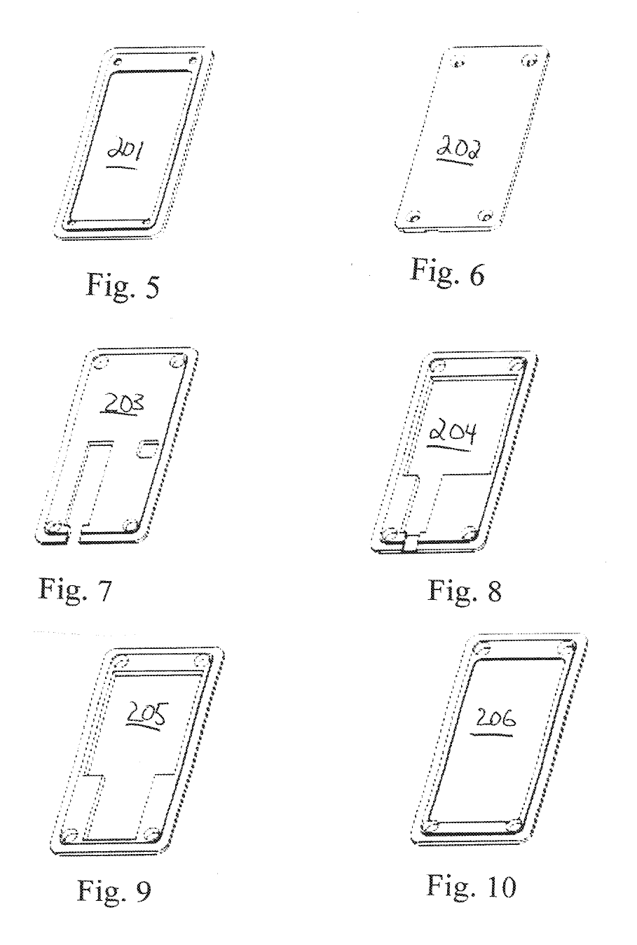

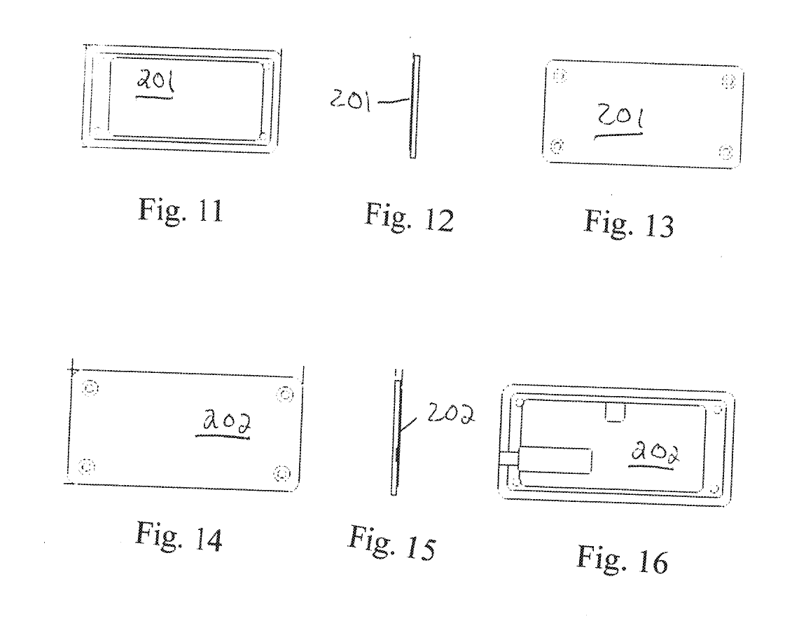

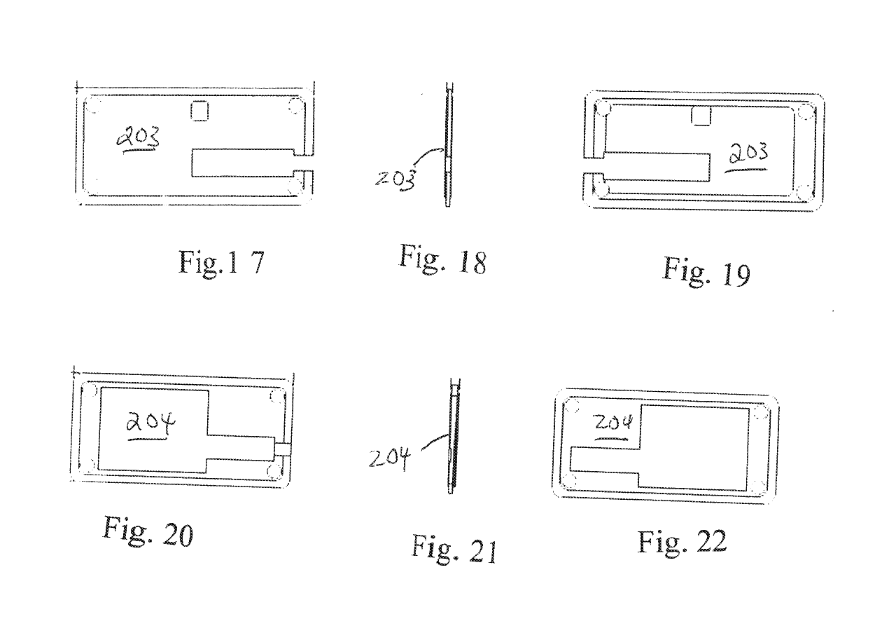

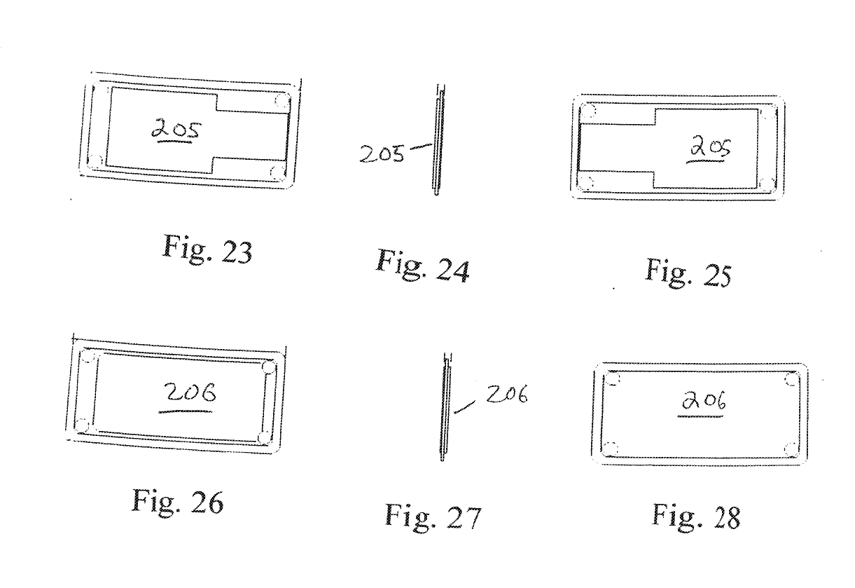

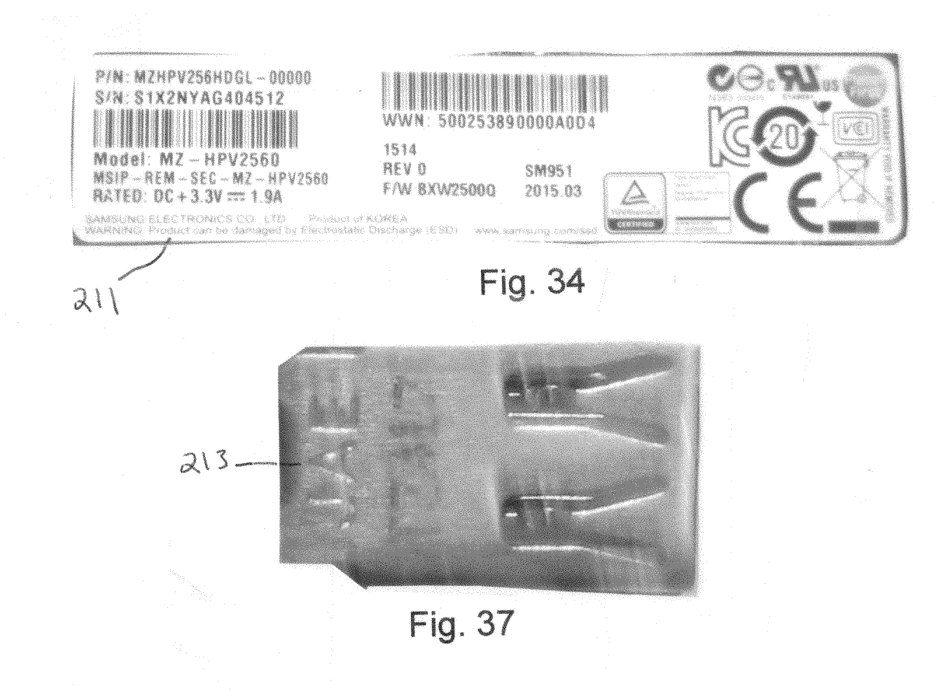

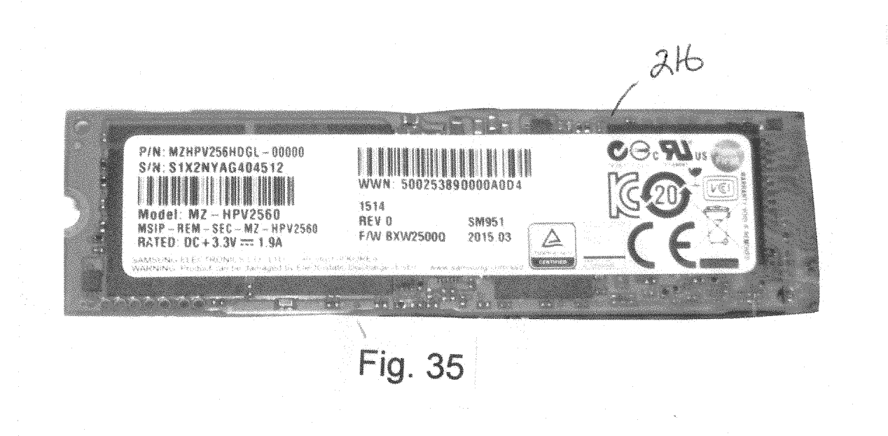

Referring to FIG. 33 in conjunction with FIG. 2, FIG. 4, FIG. 34 and FIG. 35 a PCI Express (PCIe) memory card 211 is a next-generation PCI Express-based flash storage which is up to 2.4 times faster than SATA-based solid-state drives and up to 10 times faster than a 7200-rpm SATA hard drive. So “booting” up launching applications, even opening massive files happens in, well, a flash.

The XP941 delivers a level of performance that easily surpasses the speed limit of a SATA 6 Gb/s interface. The XP941 enables a sequential read performance of 1,400 MB/s (megabytes per second), which is the highest performance available with the PCIe 2.0 interface. This allows the drive to read 500 GB of data or 100 HD movies as large as 5 GB (gigabytes) in only six minutes, or 10 HD movies at 5 GB in 36 seconds. That is approximately seven times faster than a hard disk drive (which would need over 40 minutes for the same task), and more than 2.5 times faster than the fastest SATA SSD. The XP941 comes in the new M.2 form factor (80 mm×22 mm), weighing approximately six grams—about a ninth of the 54 grams of a

SATA-based 2.5 inch SSD. The XP941's volume is about a seventh of that of a 2.5 inch SSD, freeing up more space for the notebook's battery and therein providing the opportunity for increased mobility that will enhance user convenience.

Most M.2 PCIe SSDs will utilize two PCI Express lanes. The XP941 communicates over four and connects to a four-lane PCI Express 30 Ultra M.2 socket. SATA Express replaces SATA 6 Gb/s.

The Thunderbolt flash drive is built around the latest generation M.2 PCIe SSD module which is the fastest standard SSD type now available. A 20 Gbps Thunderbolt 2 interface provides the bandwidth necessary for the device to sustain ultra-high file transfer speeds—fast enough to support 4K workflows. Capable of transferring files at over 1200 MB/s.

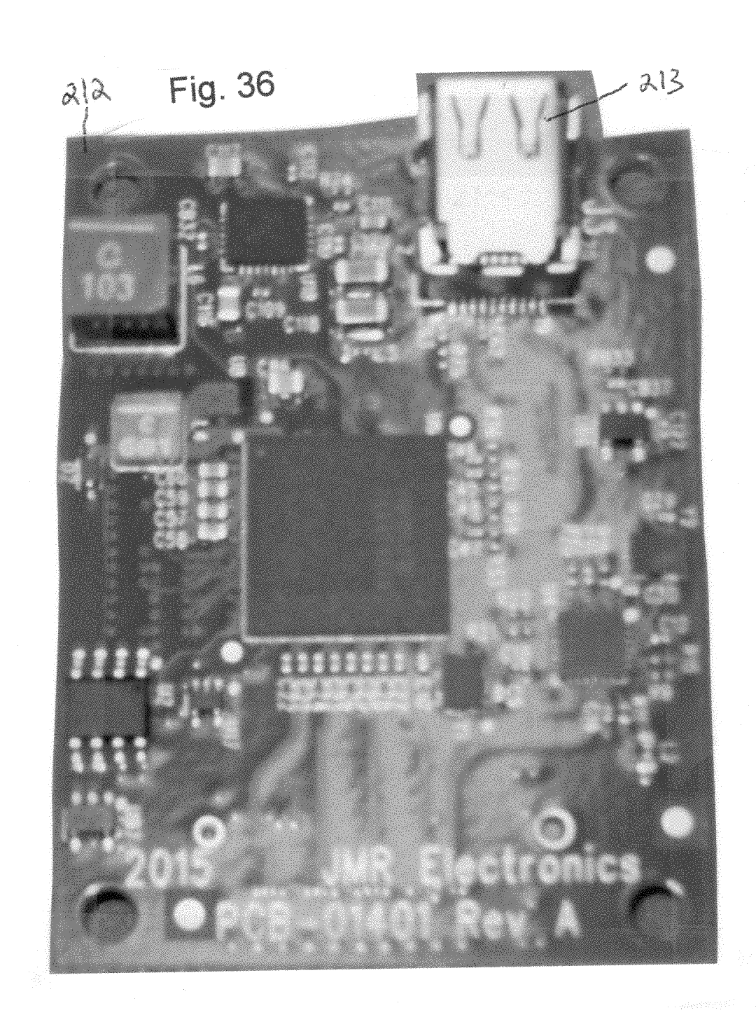

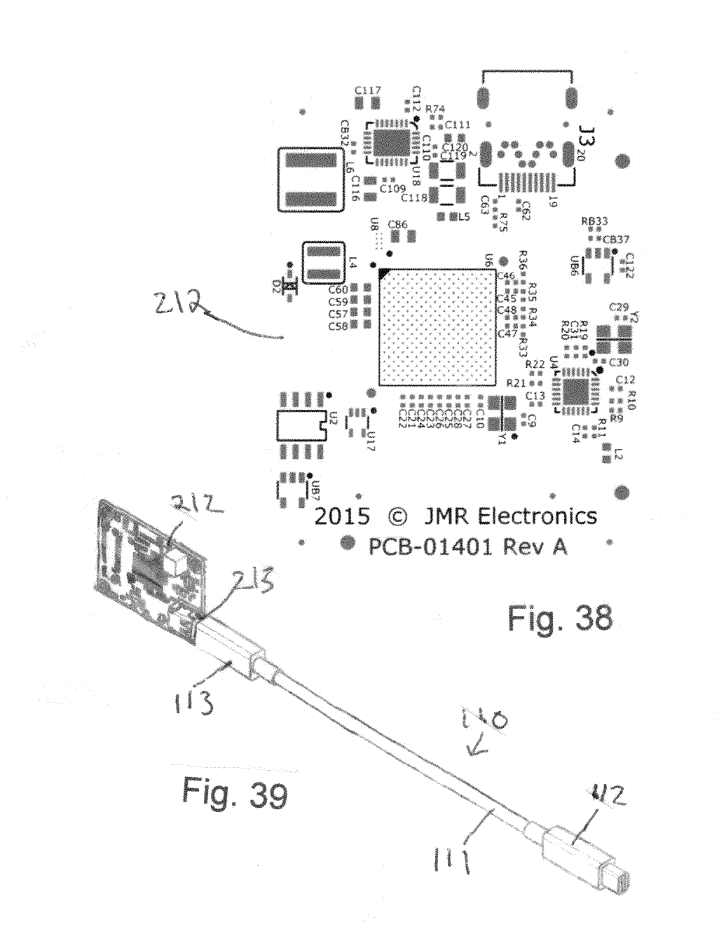

Referring to FIG. 36 in conjunction with FIG. 2, FIG. 37, FIG. 38 and FIG. 39 a controller board 212 has a Thunderbolt solid state drive adapter. The adapter has an interface for interfacing a Thunderbolt device to the PCI Express (PCIe) memory card. The interface is based on an Intel Reference Design and the PCIe M.2 form factor solid state drive device 211 which plugs into the adapter via the connector 216. The reference design includes an Intel DSL-5320 “Falcon Ridge” Thunderbolt controller device. The second connector 113 of the 0.5 m Thunderbolt cable assembly 110 plugs into the mating connector 213 on the controller board 212. The DSL-5320 integrated circuit converts two Thunderbolt lanes to Gen. 2 PCI-Express (PCIe) x4, which then interfaces with the M.2 PCIe SSD 211 via a connector 216 on the back side of the board. The board also contains voltage regulators, power switches and clock buffers. The DSL-5320 is a commodity device. The M.2 PCIe solid state drive is a commodity device. The Thunderbolt solid state drive 200 captivates the pre-attached Thunderbolt cable 110 during assembly so the Thunderbolt cable 110 cannot be stressed nor accidentally become disconnected. This is achieved by mechanical design of the “sandwich” assembly. The Thunderbolt Flash Drive 200 has a rugged enclosure which is crafted out of aluminum which effectively transfers heat from the SSD and allowed the device to be used without a fan to enable silent operation. The power-efficient design also enabled the device to be bus-powered and require no power adapter. The Thunderbolt Flash Drive 200 leverages the latest advancements in PCIe SSD design and Thunderbolt 2 technology to enable a storage device that fits neatly in the palm of your hand yet delivers the blazing-fast performance of a multi-drive RAID storage system many times its size. The Thunderbolt Flash Drive is well suited to serve as an ultra-fast shuttle drive or a take-anywhere drive for editing 4K video at offsite shoots. The Thunderbolt technology supports fast data transfers with two independent channels of 10 Gb/s each and can bond the two channels for a superfast 20 Gb/s. The application for the Thunderbolt flash drive 200 is to provide extremely fast data transfers from a computing system using the Thunderbolt I-O interface to a small, portable storage device which may then be easily moved from place to place to load stored data (files) to a different computer which may read or modify those files, or add to or replace them, for ongoing use. Thus, the application is very similar to the ubiquitous “USB (universal serial bus) thumb drives” (flash memory devices with a pluggable USB interface) in common use for several years; the primary difference is the Thunderbolt interface, which operates at 20 Gb/s as opposed to USB 3.0 which operates at only 5 Gb/s. Data transfers can occur at four times (or more) the speed, greatly accelerating workflow. When dealing with large files such as video formats, this can save users hours of time while still allowing use of a small, portable “bus-powered” (no external power supply required) device. The Thunderbolt flash drive 200 is pocketable, bus-powered, rugged, ultra-high-performance PCI Express® SSD Storage Device PCIe®. The Thunderbolt flash drive 200 features either 256 GB or 512 GB capacity, the M.2 PCI Express solid state drive Module 211 and Thunderbolt™ 2 Interface and supports data transfers over 1200 MB/second. The Thunderbolt flash drive 200 serves as an ultra-fast alternative to USB thumb drives and portable SATA-based hard disk drive and SSD storage products and it connects to a compatible Mac® computer or at the end of a Thunderbolt device daisy chain, via the attached 0.5-meter Thunderbolt cable assembly 110. The Thunderbolt solid state drive consists of an interface printed circuit board including a Thunderbolt to PCIe adapter based on an Intel Reference Design and the purchased PCIe M.2 form factor solid state drive device 211 which plugs into the adapter of the controller board 212 via the connector 216. The reference design includes an Intel DSL-5320 “Falcon Ridge” Thunderbolt controller device and a 0.5 m Thunderbolt cable assembly which plugs into a mating connector 213. The DSL-5320 integrated circuit converts two Thunderbolt lanes to Gen. 2 PCI-Express (PCIe) x4, which then interfaces with the M.2 PCI Express solid state drive via a connector on the back side of the controller board 212. The controller board 212 also contains voltage regulators, power switches and clock buffers. The DSL-5320 is a commodity device. The M.2 PCIe solid state drive 211 is a commodity device. The Thunderbolt cable assembly 110 is also a commodity device. A custom designed interface printed circuit for the controller board 212 is based on the Intel Reference Design. The M.2 interface connector 216 is on the back side of that controller board 212 essentially folded beneath the controller board 212. The packaging method used to maintain a very small outline while enhancing the power dissipation ability by use of a “sandwich” consisting of six layers of custom aluminum fabrications along with thermally conducting adhesive insulating pads. The insulating pads are elastomeric thermal interfaces having excellent thermal conductivity to provide transfer from heat-generating components to the aluminum structure that creates the “sandwich” enclosure, which in turn dissipates the heat generated internally in a highly efficient manner. The Intel® DSL5320 Thunderbolt™ 2 Controller and Thunderbolt technology support fast data transfers with two independent channels of 10 Gb/s each. The Thunderbolt 2 technology can bond the two channels for a superfast 20 Gb/s. (Note to Ed: The above is a repeat of previous statements and seems redundant.) Use this cable to connect Thunderbolt-enabled devices to the Thunderbolt or Thunderbolt 2 port on an Apple Macintosh or “Mac” generation computer, as well as other Thunderbolt-ready small computers. The Apple Thunderbolt Cable lets you connect two Thunderbolt-equipped Mac computers in target disk mode, network two Mac computers with OS X Mavericks, or use your iMac as a display for the MacBook Pro which is the professional desktop computer reinvented from the inside out. Arranging the most advanced technologies available around a unified thermal core allowed Apple to make this the most powerful and expandable Mac ever, yet also unbelievably compact and quiet. The new Mac Pro features the latest Intel Xeon E5 processor, with up to 12-core processing power and a four-channel memory controller providing up to 60 GB/s of memory bandwidth, all on a single die. And with 40 lanes of PCI Express gen 3 throughput, up to 30MB of L3 cache, and over 500 gigaflops at peak performance, you'll never be at a loss for speed. Every new Mac Pro comes standard with dual AMD FirePro workstation-class GPUs, each with up to 6 GB of dedicated VRAM and 2048 stream processors, providing up to 264 GB/s of memory bandwidth and up to 3.5 teraflops. That's enough power to edit full-resolution 4K video while simultaneously rendering effects in the background—and still connect up to three 4K displays. Thunderbolt 2 delivers throughput of up to 20 Gb/s to each external device. And since each Thunderbolt 2 port allows you to daisy-chain up to six peripherals, you can connect massive amounts of storage, add a PCI Express expansion chassis, and work with the latest 4K displays.

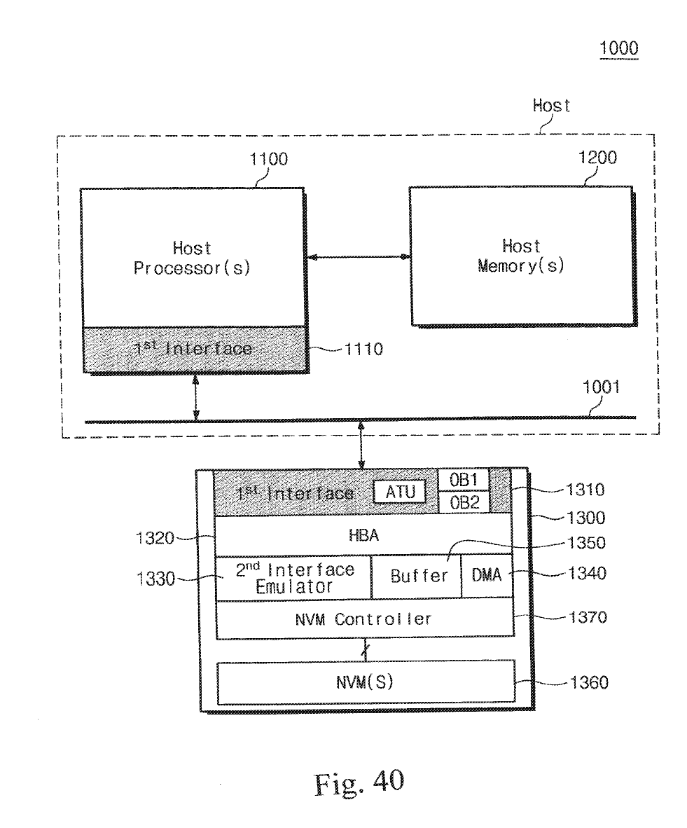

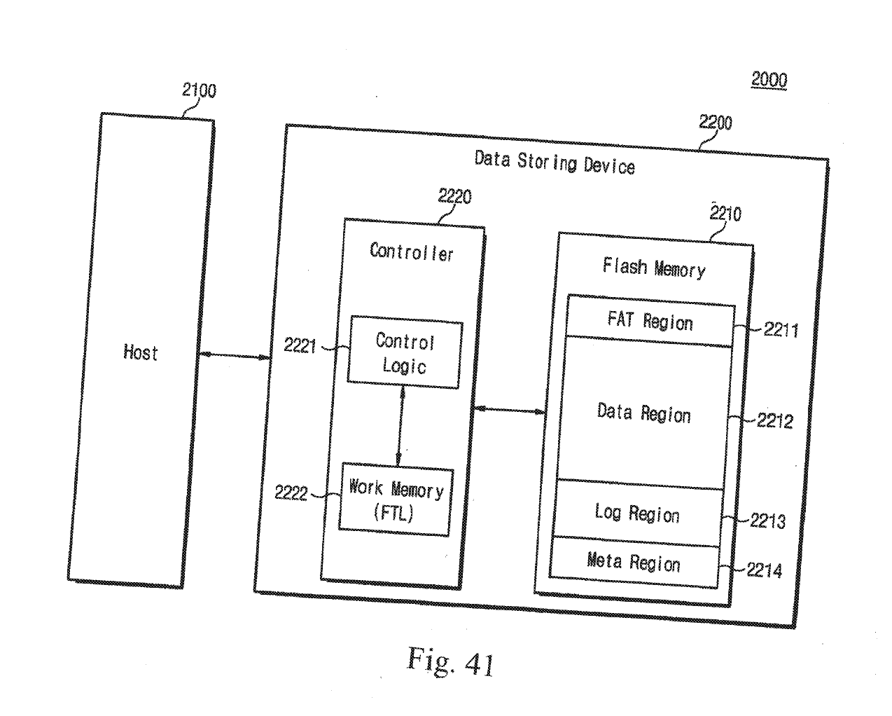

Referring to FIG. 36 in conjunction with FIG. 2, FIG. 33, FIG. 34 and FIG. 35 the Thunderbolt flash drive 200 includes a PCI Express solid state device and a controller. The controller is electrically coupled to the PCI Express solid state device. The controller has a Thunderbolt mating connector and a PCI Express mating connector. The PCI Express solid state drive device is inserted into the PCI Express mating connector. The cable connector of the Thunderbolt cable assembly plugs into the Thunderbolt mating connector. The controller converts two lanes to Gen. 2 PCI-Express x4 and interfaces with the PCI Express solid st Referring to FIG. 40 a block diagram schematically illustrates a first computer 1000 which U.S. Patent Publication No. 2014/0149705 teaches. The computer 1000 includes a host bus 1001, at least one host processor 1100, at least one host memory 1200 and a storage device 1300. The components 1001, 1100 and 1200 are referred to as a host. The host bus 1001 transfers data according to a first interface between components (e.g., processor 1100 and the storage device 1300) of the computing system 1000. The first interface be a FC (Fiber Channel) interface, a USB (Universal Serial Bus) 3.0 interface, a USB 2.0 interface, a SAS (Serial Attached SCSI), a PCI (Peripheral Component Interconnect) Express) interface, an SPI (Serial Peripheral interface), a thunderbolt Interface, a lightning bolt interface or other like interfaces. The host processor 1100 controls an overall operation of the computer 1000. The host processor 1100 includes a first interface circuit 1110. The first interface circuit 1110 is connected with the host bus 1001 according to the first interface. The host processor 1100 includes a memory controller (not shown) configured to control the host memory 1200. The host memory 1200 is connected with the host processor 1100 and stores data used during an operation according to a control of the host processor 1100. The host memory 1200 is implemented using a volatile memory device such as a DRAM, a nonvolatile memory device such as a PRAM, or other like memory device. The storage device 1300 is connected with the host bus 1001 according to the first interface, and stores data. The storage device 1300 is configured to communicate with the host via the first interface and perform a data transfer operation internally according to a second interface. The second interface is an ATA interface, a SATA interface or other like interface. The storage device 1300 includes a first interface circuit 1310 (referred to as an external interface circuit), a host bus adaptor 1320, a second interface emulator 1330 (referred to as an internal interface circuit), a DMA circuit 1340, a buffer memory 1350, at least one nonvolatile memory device 1360 and a memory controller 1370. The first interface circuit 1310 is connected with the host bus 1001 according to the first interface. The first interface circuit 1310 includes an address translation unit ATU, a first outbound area OB1, and second outbound area OB2. The address translation unit ATU supports transactions between the first and second outbound areas OB1 and OB2 of the storage device 1300 and an area of the host memory 1200. The address translation unit ATU is configured to designate an area of the host memory 1200 to correspond to the first and second outbound areas OB1 and OB2, such that the storage device 1300 sees the particular area of the host memory 1200. To read/write data to/from the first and second outbound areas OB1 and OB2, the first and second outbound areas OB1 and OB2 corresponds to read/write data from/to the designated area of the host memory 1200. In other words, the first and second outbound areas OB1 and OB2 is a window of the designated area of the host memory 1200. Thus, setting the address translation unit ATU entails setting an address of the designated area of the host memory 1200 windowed to the first and second outbound areas OB1 and OB2. The host bus adaptor 1320 is configured to communicate with the first interface circuit 1310 according to the first interface and with second interface emulator 1330 according to the second interface. The host bus adaptor 1320 is implemented using software, hardware, or a combination of software and hardware, such that the storage device 1300 understands at least one command output from the host processor 1100. The host bus adaptor 1320 is an MCI (Advanced Host Controller Interface) or other like bus adaptor. Additionally, the first outbound area OB1 and the second outbound area OB2 each have a variable size, such that the storage device 1300 change the size of each of the first outbound area OB1 and the second outbound area OB2. The second interface emulator 1330 communicates with the host bus adaptor 1320 according to the second interface. The second interface emulator 1330 is implemented to provide second interface emulation for the storage device 1300. The second interface emulator 1330 is configured to communicate with the host bus adaptor 1320 using a frame information structure (FIS) of the second interface. The second interface emulator 1330 is configured to process a FIS transaction to/from the memory controller 1370 or a FIS of the host via the host bus adaptor 1320. The DMA circuit 1340 is configured to control the first interface circuit 1310 according to a command input from the host processor 1100, such that the storage device 1300 directly reads/writes data from/to the host memory 1200. Where reprogramming the address translation unit ATU is required during data transfer, the DMA circuit 1340 is configured to reprogram the address translation unit ATU to use the second outbound area OB2 without using the first outbound area OB1. That is, when the first outbound area OB1 is being used during a data transfer operation, the second outbound area OB2 is employed for reprogramming of the address translation unit ATU. Because the second outbound area OB2 is used for reprogramming the address translation unit ATU without using the first outbound area OB1, the reprogramming operation is considered “hidden” from the data transfer operation. The DMA circuit 1340 is configured to control the address translation unit ATU in order to use the first outbound area OB1 and the second outbound area OB2 to hide a reprogramming time of the address translation unit ATU during a data transfer operation. The buffer memory 1350 temporarily stores data necessary for an operation of the storage device 1300. The buffer memory 1350 is implemented by a volatile memory such as a DRAM, an SRAM, or other like memory device. The at least one nonvolatile memory device 1360 is configured to store data, and is at least one of a flash memory (e.g., a NAND flash memory), a phase-change RAM (PRAM), a magnetic RAM (MRAM), a resistive RAM (RRAM), a ferroelectric RAM (FRAM), a vertical NAND (VNAND), or other like data storage device. The memory controller 1270 controls the at least one nonvolatile memory device 1360 according to a FIS transaction transferred from the second interface emulator 1330. The FIS transaction is made according to an input/output request or command of the host. The computing system 1000 is configured such that a DMA circuit 1340 performs a data transfer operation and a reprogramming operation of the address translation unit ATU in parallel using the two outbound areas OB1 and OB2. Thus, it is possible to reduce overhead associated with an address translation and/or a loss of data during a data transfer. A DMA circuit 1340 transfers first write data to the first outbound area OB1 in response to a first write command Write #1. The first write data transferred to the first outbound area OB1 is transferred to a first area of a host memory 1200 corresponding to an address set by the address translation unit ATU. When the address translation unit ATU necessitates reprogramming during a transfer of the first write data, second write data is transferred to the second outbound area OB2 in response to a second write command Write #2. The DMA circuit 1340 sends a signal or other indication that a reprogramming of the address translation unit ATU based on a determined size of the second write data and/or a size of the second area of the host memory 1200. The address translation unit ATU is reprogrammed if a size of the write data is determined to exceed at least one of a size of the first outbound area OB1 and a size of the second outbound area OB2. When a transfer of the first write data in the first outbound area OB1 to an area of the host memory 1200 is completed, the DMA circuit 1340 request a dummy read operation of the memory location of the host memory 1200 to which the first write data is sent. After the dummy read operation is completed, the DMA circuit 1340 sends the second write data stored at the second outbound area OB2 to the first area of the host memory 1200. When reprogramming of the address translation unit ATU is required during a transfer of the second write data, a third write data is sent to the first outbound area OB1 in response to a third write command Write #3.

Referring to FIG. 41 a block diagram schematically illustrates a second computer system 2000 which U.S. Pat. No. 8,990,402 teaches. The second computer system 2000 includes a host computer 2100 and a memory 2200. The memory 2200 includes a flash memory 2210 and a controller 2220 for interfacing between flash memory 2210 and the host computer 2100. The flash memory 2210 includes a plurality of memory cells arranged in a memory cell array. The memory cell array is divided into a plurality of blocks. Each block is divided into a plurality of pages. Each page includes a plurality of memory cells sharing a common word-line. The flash memory 2210 is erased a block at a time and either read or programmed a page at a time. The pages of flash memory 2210 can only be programmed when in an erased state. The flash memory 2210 does not have “write in place” capability. The flash memory 2210 includes a NAND flash memory. The host system 2100 accesses the memory system 2200 as if it were a conventional hard disk with write in place capability. Since the flash memory 2210 does not have write in place capability, the controller 2220 includes a flash translation layer (FTL) which gives the host system 2100 the appearance of write in place capability while actually programming data to different pages of the flash memory 2210. The flash memory 2210 includes a file allocation table (FAT) region 2211 storing a file allocation table, a data region 2212, a log region 2213, and a meta-region 2214.

The log region 2213 includes a plurality of log blocks 2213 corresponding to a plurality of respective data blocks in data region 2212. When the host system 2100 initiates a program operation for a data block in data region 2212, data for the program operation is programmed in a corresponding log block of the log region 2213. Where a data block in data region 2212 does not have a corresponding log block in log region 2213, or where there is no empty page in a log block in log region 2213, or where a host makes a merge request, a merge operation is performed. In the merge operation, valid pages of data blocks and corresponding log blocks are copied to new data and log blocks. Once the merge operation is performed, mapping information for logical addresses and physical addresses of flash memory 2210 are stored in meta-region 2214. The controller 2220 is configured to control memory system 2200 when host system 2100 performs a memory access operation. The controller 2220 includes a control logic circuit 2221 and a working memory 2222. The FTL is stored in working memory 2222. When host system 2100 initiates a memory access operation, control logic circuit 2221 controls the FTL.

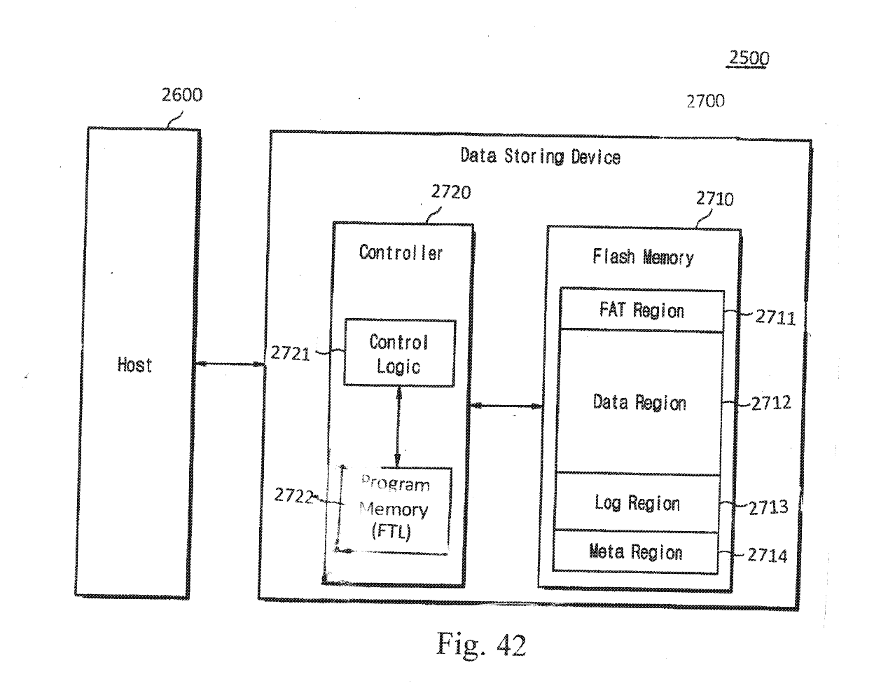

Referring to FIG. 42 a block diagram schematically illustrates a third computer system 2500 which is similar to the second computer system 2000. The third computer system 2000 includes a host computer 2600 and a memory 2700. The memory 2700 includes a flash memory 2760 and a controller 2720 for interfacing between flash memory 2760 and the host computer 2600. The flash memory 2760 includes a plurality of memory cells arranged in a memory cell array. The memory cell array is divided into a plurality of blocks. Each block is divided into a plurality of pages. Each page includes a plurality of memory cells sharing a common word-line. The flash memory 2760 is erased a block at a time and either read or programmed a page at a time. The pages of flash memory 2760 can only be programmed when in an erased state. The flash memory 2760 does not have “write in place” capability. The flash memory 2760 includes a NAND flash memory. The host system 2600 accesses the memory system 2700 as if it were a conventional hard disk with write in place capability. Since the flash memory 2760 does not have write in place capability, the controller 2720 includes a flash translation layer (FTL) which gives the host system 2600 the appearance of write in place capability while actually programming data to different pages of the flash memory 2760. The flash memory 2760 includes a file allocation table (FAT) region 2761 storing a file allocation table, a data region 2762, a log region 2763, and a meta-region 2764. The log region 2763 includes a plurality of log blocks 2763 corresponding to a plurality of respective data blocks in data region 2762. When the host system 2600 initiates a program operation for a data block in data region 2762, data for the program operation is programmed in a corresponding log block of the log region 2263. Where a data block in data region 2762 does not have a corresponding log block in log region 2763, or where there is no empty page in a log block in log region 2763, or where a host makes a merge request, a merge operation is performed. In the merge operation, valid pages of data blocks and corresponding log blocks are copied to new data and log blocks. Once the merge operation is performed, mapping information for logical addresses and physical addresses of flash memory 2760 are stored in meta-region 2764. The controller 2720 is configured to control memory system 2700 when host system 2600 performs a memory access operation. The controller 2720 includes a control logic circuit 2726 and a program memory 2727. The FTL is stored in the program memory 2727. When host system 2600 initiates a memory access operation, control logic circuit 2726 controls the FTL.

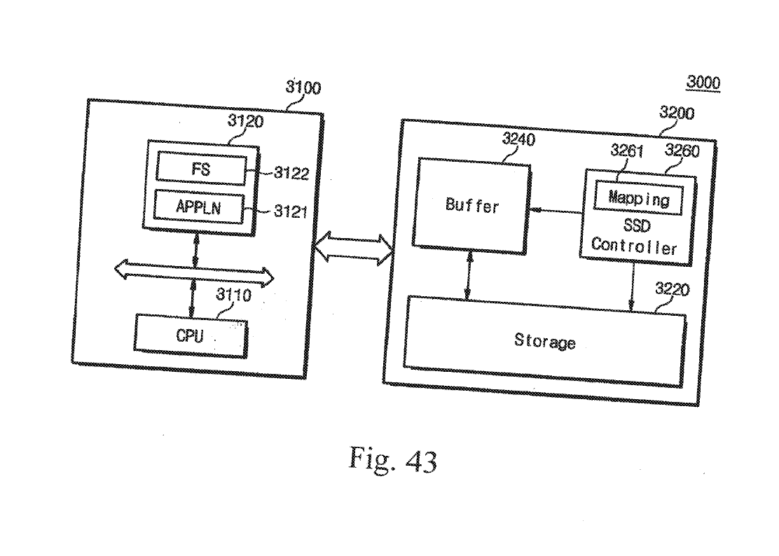

Referring to FIG. 43 a user device 3000 includes a host 3100 and a storage device 3200. The storage device 3200 include a storage device coupled to the host 3100 using a standardized interface, such as PATA, SCSI ESDI, PCI-Express, SATA, wired USB, wireless USB and/or IDE interfaces. Other types of interfaces, including nonstandard interfaces, are used to couple the host 3100 and the storage device 3200. The storage device 3200 includes memory integrated with the host 3100. The host 3100 includes a central processing unit (CPU) 3110 and a memory 3120. The memory 3120 includes a main memory of the host 3100. An application program 3126 and a file system 3127 are embodied in the memory 3120. The file system 3127 includes one or more file systems having a file allocation table (FAT) or other file system. The host 3100 outputs an Invalidity Command to the storage device 3200 when all or some of the data of a file processed by the application program 3126 is to be deleted. The host 3100 transmits the Invalidity Command accompanied by information relating to an address and/or size of the data to be deleted to the storage device 3200. A FAT file system includes a master boot record (MBR), a partition boot record (PBR), first and second file allocation tables (primary FAT, copy FAT) and a root directory. The data stored or to be stored in the storage device 3200 can be identified using two items of information, such as a file name including the data and a path of a directory tree for reaching a place where the file is stored. Each entry of a directory stores information, such as a length of file (e.g., 32 bytes long), a file name, an extension name, a file property byte, a last modification date and time, a file size and a connection of a start-up cluster. A predetermined character is used as a first character of a file name to indicate a deleted file. A hexadecimal number byte code E5h is assigned to the first character of the file name for a deleted file to serve as a tag for indicating that the file is deleted. When a file is deleted, the CPU 110 assigns a predetermined character as the first character of the file name of the deleted file and also output an Invalidity Command and/or other invalidity information corresponding to the deleted file to the storage device 3200. The storage device 3200 includes a storage medium 3270, a buffer memory 3240 and a SSD controller 3260. The storage device 3200 prevents writing of data stored in the buffer memory 3240 to the storage medium 3270 when the data of a file is considered deleted at a higher level of the storage device 3200 and an invalidity indicator has been input to the storage device 3200. The invalidity indicator includes the Invalidity Command, along with information about an address and a size of the deleted data. The storage medium 3270 stores all types of data, such as text, images, music and programs. The storage medium 3270 is a nonvolatile memory, such as a magnetic disk and/or a flash memory. The buffer memory 3240 is used to buffer data transfer between the host 3100 and storage medium 3270. The buffer memory 3240 include high speed volatile memory, such as dynamic random access memory (DRAM) and/or static random access memory (SRAM), and/or nonvolatile memory, such as magneto-resistive random access memory (MRAM), parameter random access memory (PRAM), ferroelectric random access memory (FRAM), NAND flash memory and/or NOR flash memory. The buffer memory 3240 serves as a write buffer. The buffer memory 3240 temporarily stores data to be written in the storage medium 3270 responsive to a request of the host 3100.

The write buffer function of the buffer memory 3240 can be selectively used. Occasionally, in a “write bypass” operation, data transferred from the host system is directly transferred to the storage medium 3270 without being stored in the buffer memory 3240. The buffer memory 3240 also works as a read buffer. The buffer memory 3240 temporarily stores data read from the storage medium 3270. Although FIG. 42 shows only one buffer memory, two or more buffer memories can be provided. Each buffer memory is used exclusively as a write buffer or read buffer or serve as a write and read buffer. The SSD controller 3260 controls the storage medium 3270 and the buffer memory 3240. When a read command is input from the host 3100, the SSD controller 3260 controls the storage medium 3270 to cause transfer of data stored in the storage medium 3270 directly to the host 3100 or to cause transfer of data stored in the storage medium 3270 to the host 3100 via the buffer memory 3240. When a write command is input from the host 3100, the SSD controller 3260 temporarily stores data related to the write command in the buffer memory 3240. All or part of the data stored in the buffer memory 3240 is transferred to the storage medium 3270 when the buffer memory 3240 lacks room for storing additional data or when the storage device 3200 is idle. The storage device 3200 is considered idle when no requests have been received from the host 3100 within a predetermined time. The SSD controller 3260 holds address mapping information for the storage medium 3270 and the buffer memory 3240 and a mapping table 3261 for storing write state information representing validity/invalidity of stored data. The write state information is updated by invalidity information (e.g., an indicator) provided from an external device. The SSD controller 3260 controls the storage medium 3270 and the buffer memory 3240 to write all or part of data stored in the buffer memory 3240 to the storage medium 3270 based on the write state information in the mapping table 3261 The storage medium 3270 and the buffer memory 3240 is embodied using a flash memory. The storage device 3200 determines whether or not to transfer all or part of data stored in the buffer memory 3240 to the storage medium 3270 by referring to the write state information. The storage device 3200 receives the invalidity or other information representing that data stored in the buffer memory 3240 is invalid data from an external source device, such as the host 3100. In response to the invalidity or other invalidity indicator, the storage device 3200 prevents writing of invalid data to the storage medium 3270 from the buffer memory 3240. In other words, the storage device 3200 assigns a tag representing invalidity of data stored in the buffer memory 3240 and selectively transfers data stored in the buffer memory 3240 to the storage medium 3270 based on the assigned tag. A write performance of the storage device 3200 is improved, which can reduce shortening of the lifetime of the storage device 3200 caused by unnecessary write operations. Power consumed by unnecessary write operations is reduced. In recent years, a solid state drive (SSD) has been used as a storage device of a computing system. The SSD employs a nonvolatile memory (e.g., a flash memory) to store data. Compared with a typical hard disk drive, the SSD is advantageous in terms of endurance, size, power, and so on. The SSDs is divided into a Peripheral Component Interconnect (PCI) SSD and a Serial Advanced Technology Attachment (SATA) SSD according to a communication method with a host.

What is claimed is:

1. A combination Thunderbolt cable assembly and Thunderbolt flash drive comprising
a. a housing;
b. a Thunderbolt cable assembly including a cable, a first cable connector and a second cable connector wherein said second cable connector is mechanically coupled to said housing; and
c. a Thunderbolt flash drive wherein said Thunderbolt flash drive includes:
i. a PCI Express solid state device;
ii. a controller electrically coupled to said PCI Express solid state device wherein said controller has a Thunderbolt mating connector and a PCI Express mating connector and wherein said PCI Express solid state drive device is inserted into said PCI Express mating connector and said cable connector plugs into said Thunderbolt mating connector whereby said controller converts two lanes to Gen. 2 PCI-Express x4 and interfaces with said PCI Express solid state device via said Thunderbolt mating connector.

2. A combination Thunderbolt cable assembly and Thunderbolt flash drive according to claim 1 wherein said housing includes
a. a first rectangular plate having a hole in each of four corners each of which receives one of four threaded bushings;
b. a second rectangular plate having a hole in each of four corners each of which receives one of four threaded bushings and being coupled to said first plate;
c. a first rectangular thermal pad disposed between said first and second plates;
c. a third rectangular plate having a hole in each of four corners each of which receives one of four threaded bushings and being coupled to said first plate; d. a second rectangular thermal pad disposed between said second and third plates;
e. a fourth rectangular plate having a hole in each of four corners each of which receives one of four threaded bushings and being coupled to said first plate;
f. a third rectangular thermal pad disposed between said third and fourth plates;
g. a fifth rectangular plate having a hole in each of four corners each of which receives one of four threaded bushings and being coupled to said first plate;
h. a fourth rectangular thermal pad disposed between said fourth and fifth plates; and
i. a sixth rectangular plate coupled to said fifth plates;
j. four bushings being threaded at each end wherein one of said four bushings is inserted into said hole in each of said four corners of said first, second, third, fourth, fifth and sixth plates; and
k. eight screws wherein one of each of said eight screws is threadedly coupled to each end of said four bushings whereby a said housing is formed.
